(19) United States
(12) Patent Application Publication
(10) Pub. No.: US 2015/0325868 A1
(43) Pub. Date: Nov. 12, 2015

(54) Humidifier, such as for a Fuel Cell

(71) Applicant: MANN+HUMMEL GMBH, Ludwigsburg (DE)

(72) Inventor: Michael Fasold, Auenwald (DE)

(21) Appl. No.: 14/701,864

(22) Filed: May 1, 2015

(30) Foreign Application Priority Data
May 6, 2014 (DE) 10 2014 006 465.4

(51) Int. Cl. H01M 8/04; F24F 3/14; B01F 3/04

(52) U.S. Cl. CPC H01M 8/04149; B01F 3/04007; F24F 3/14; B01F 2215/0098; F24F 2003/1435

(57) ABSTRACT

A humidifier includes at least two pleated membranes which are disposed on top of each other.

### TECHNICAL FIELD

The invention relates to a humidifier, such as for a fuel cell, according to the preamble of claim 1.

### BACKGROUND

Known humidifiers for fuel cells, which are described in DE 10 2009 034 095 A1 or EP 1 261 992 B1, for example, comprise multiple membranes, which are located in parallel planes and separate interposed flow channels through which moist or dry air is conducted. Water molecules penetrate each membrane from the moist to the dry air flow, which is thus enriched with moisture. The humidified air flow is supplied to a fuel cell system in which power is generated in an electrochemical reaction.

According to DE 10 2009 034 095 A1, multiple membranes located on top of each other are combined to form a stack. The edge regions of the membranes are connected to frame parts of a housing, wherein a sealing element is disposed between the frame parts of adjacent membranes to provide leak-proof sealing. The dry or moist air flows crosswise through superimposed flow channels between which a respective membrane is disposed. The frame parts and the interposed sealing elements at the same time serve as spacers so as to fix the membranes clamped in parallel to each other at a distance from each other.

### SUMMARY OF THE INVENTION

It is the object of the invention to create a humidifier that has a simple and compact design and comprises a plurality of flow channels through which a dry or moist gas flow flows.

The humidifier according to the invention allows flowing air to be enriched with moisture, so that a required minimum moisture content is achieved in the air flow. The humidifier is used in fuel cells, for example, in which power is generated in an electrochemical reaction. The air enriched with moisture is supplied to the inlet of the fuel cell. On the outlet side, the waste air leaves the fuel cell with a relatively high moisture content; the waste air is introduced into the humidifier, in which the moisture is delivered to the incoming fresh air flow by way of the membranes.

The humidifier can also be used in other technical fields. For example, the humidifier can be used to humidify the breathing air in closed rooms or cabins, such as in airplanes.

The humidifier comprises at least two superimposed membranes that are permeable to water and accommodated in a housing. A respective gas flow is conducted along the opposing sides of each membrane, wherein the gas flows have different moisture content levels. Water from the gas flow having the higher moisture content reaches the gas flow having the lower moisture content through the membranes.

In the humidifier according to the invention, each of the at least two superimposed membranes is accommodated in the housing in a pleated manner. The various pleats of the membrane separate the flow channels for the gas flows having the higher and the lower moisture content, which is at least partially compensated for through the membranes. Each membrane can be pleated multiple times, which significantly simplifies the design compared to conventional humidifiers comprising a stacked unit having multiple membranes disposed in each case in parallel planes. Essentially only a single membrane per layer of the humidifier suffices for the design according to the invention, however optionally it can be pleated multiple times. However, it is also possible to use multiple membranes per layer, which directly adjoin each other. At least two, and optionally more than two, membranes are superimposed in the humidifier.

An additional increase in efficiency can be achieved by the superimposed stacking of the membranes in the humidifier, wherein each membrane can have a pleated design. The membranes can be accommodated in a shared housing. However, advantageously each membrane is disposed in a separate humidification module comprising a module housing, wherein the module housings are stackable. This design has the advantage that the membranes are rigidly accommodated in the respective module housing, and sealing between the different sides of the membrane is achieved within a module housing.

Two humidification modules in each case are advantageously stacked in a mirror-symmetrical manner. For example, two humidification modules can be joined at the bottoms thereof, which has the advantage that a gas flow to be supplied laterally can be introduced via a shared inflow opening into the respective flow channels of the membranes. This gas flow is discharged in a corresponding manner via a shared outflow opening on the opposite housing side. Overall, this reduces the number of connections for supplying and discharging the gas flow.

According to a further advantageous embodiment, the mirror-symmetrically stacked humidification modules are placed on top of each other without a bottom plate or cover plate in the abutting region. In this way, a shared flow chamber for the gas flow to be supplied is obtained in the interior of the humidifier, the gas flow being divided between the flow channels of the membrane located at the top and that located at the bottom. The shared flow chamber is located in the center between the membrane located at the top and that located at the bottom. For example, fresh air having reduced moisture is introduced into this flow chamber, while the gas flow having an increased moisture content runs on the side of each membrane, which face away from the central flow chamber.

It can be advantageous to separate the shared flow chamber between the membranes by way of an additional separating element, so as to ensure that the introduced gas flow makes direct contact with each membrane side, and thus efficient moisture exchange can be carried out via the membrane. The interposed separating element prevents a rectilinear flow through the humidifier between the inflow and outflow openings. The separating element is made of nonwoven fabric, for example, wherein another woven fabric or a superabsorbent material is also possible.

It can be advantageous to insert spacers in the pleats of the membrane, which stabilize the pleats and prevent the pleats from collapsing. In particular when a pressure difference exists between the gas flows having the higher and lower moisture contents, the spacers are used to stabilize the pleats. However, it may be sufficient to insert the spacers only into the pleats of the gas flow having the lower pressure, since collapsing of the pleats in the other gas flow is prevented by the higher pressure.

The spacers advantageously extend across the length of the pleats. For example, they are designed as a rectangular insertion part, which is held on a base plate. A plurality of such insertion parts can be accommodated on the base plate, which in each case protrude into a pleat of the membrane. The spacers are advantageously implemented separately from the base plate and are inserted into the base plate. Insertion openings are optionally introduced into the base plate, via which the spacers can be inserted into the installation position thereof on the base plate. It can be advantageous to integrally mold some of the spacers onto the base plate, and to install some of the spacers through the insertion opening. An insertion opening is introduced into the base plate for every other spacer, for example.

According to a further advantageous embodiment, the spacers comprise a base carrier, which optionally can be implemented as a plate and carries transverse sections, which establish the pleat width. The base carrier preferably extends across the pleat length; the transverse sections can be disposed in various positions along the height of the base carrier and have differing widths, depending on the height position. In this way, the tapering pleat width in the direction of the pleat base can be complemented.

The gas flow along the pleat in which a spacer is inserted can be conducted along the two sides of the base plate. The transverse sections, which support the membrane, can form a meander-shaped flow channel along the base carrier, through which the gas is conducted. The meander structure of the flow channel on one side, or optionally on both sides, of the base carrier ensures sufficiently long contact of the gas flow conducted through the flow channel with the membrane to achieve the desired exchange of moisture.

The spacers, in particular the base carrier, can comprise a sealing element in the region of the end face, the sealing element being either integrally molded onto the spacer or connected to the spacer in another manner. The sealing element ensures a leak-proof connection between the end edge of the spacer and an accommodating housing of the humidifier. The sealing element on the spacer optionally cooperates with a further sealing element on the housing in the manner of a labyrinth seal.

So as to support the membrane, which is made of a very thin material, advantageously a support grid is seated against at least one side of the membrane, the support grid being made of plastic or metal, for example, and extending at least approximately, and preferably completely, on one side across the surface of the membrane. The flow openings in the support grid allow sufficient flow exchange between different sides of the membrane. The membrane and the support grid can be connected to each other. Optionally, however, the membrane is only loosely seated on the support grid. Possible embodiments include those in which a support grid is only provided on one side of the membrane, and those comprising support grids on both membrane sides.

According to still another advantageous embodiment, sealing elements are integrally molded onto the end faces of the membrane. These sealing elements, which extend along the end edges of the pleats of the membrane, also prevent improper air flows between the different sides of the membrane.

So as to seal the membrane at the edge, it is also possible for two comb-shaped lateral frame parts to engage each other.

### BRIEF DESCRIPTION OF THE DRAWINGS

Further advantages and advantageous embodiments will be apparent from the remaining claims, the description of the figures, and the drawings. In the drawings:

FIG. 1 shows a humidification module for a humidifier, such as for a fuel cell, comprising a module housing, in which a pleated membrane that is permeable to water is accommodated, wherein plate-shaped spacers are introduced into the pleats of the membrane;

FIG. 2 shows an enlarged sectional view through the humidifier transversely to the longitudinal plane of the spacers;

FIG. 3 shows an end face view of the spacers held on a base plate;

FIG. 4 shows a perspective view of the spacers held on the base plate;

FIG. 5 shows a perspective view of the humidifier comprising two humidification modules stacked on top of each other;

FIG. 6 shows a sectional view through the humidifier according to FIG. 5; and

FIG. 7 shows a further sectional view analogously to FIG. 5, however in a parallel offset plane.

In the figures, identical components are denoted by the same reference numerals.

### DETAILED DESCRIPTION OF THE INVENTION

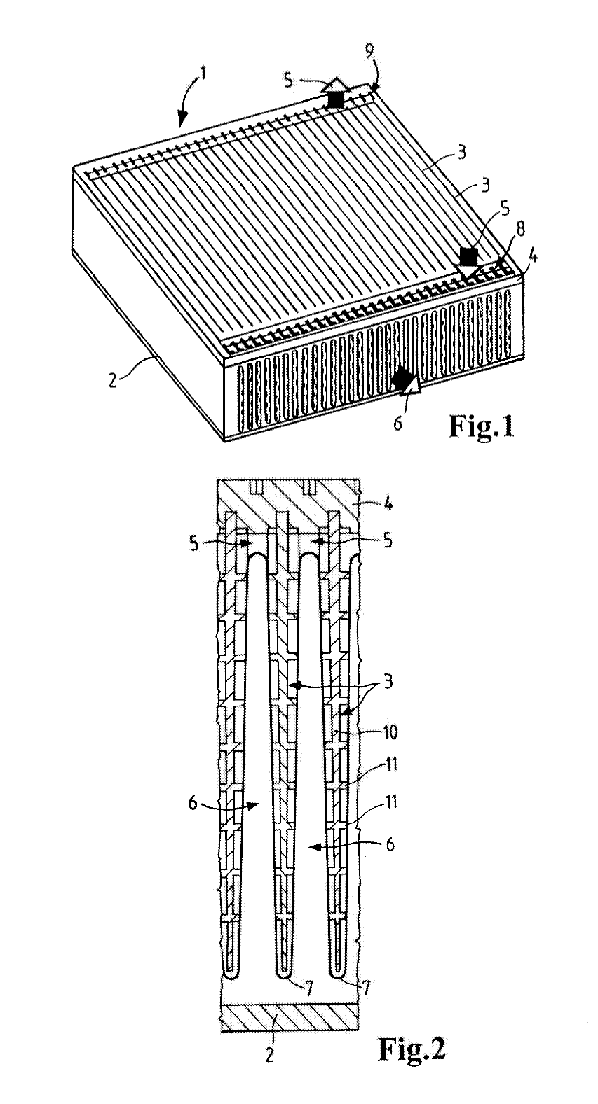

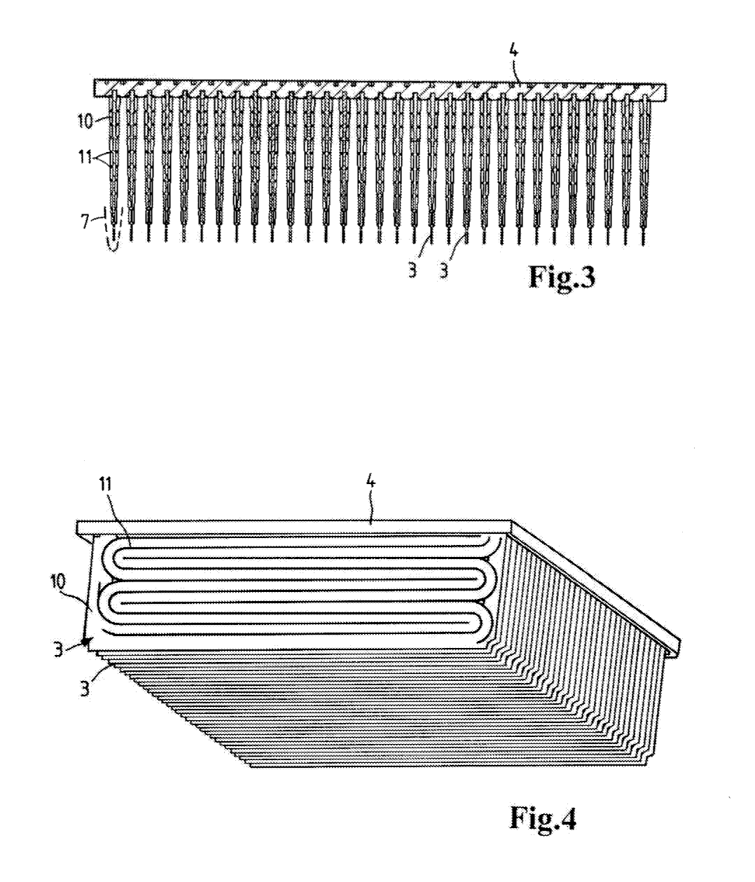

FIGS. 1 to 4 show a humidification module 1, which can be used, for example, to enrich supply air for a fuel cell with moisture. The humidification module 1 forms a moisture exchanger, in which a first gas flow having a high moisture content is introduced according to the arrows 5 into the module housing 2 of the humidification module 1, or is discharged therefrom, and, at the same time perpendicularly thereto, a second gas flow 6 having a low moisture content is likewise conducted through the housing 2. A pleated membrane, which is designed to be permeable to water, is located in the housing 2, wherein the gas flow 5 having the high moisture content is conducted on one side of the membrane, and the gas flow 6 having the low moisture content is conducted on the opposite side of the membrane. A moisture exchange from the moist gas flow 5 to the gas flow 6 having the low moisture content takes place through the membrane, so that the gas flow 6 is enriched with moisture. The gas flow 5 is the exhaust gas flow of the fuel cell, for example, which has a relatively high moisture content, and the gas flow 6 is a fresh air flow that is supplied from the surroundings and has a lower moisture content, which is supplied as an input flow to the fuel cell and must be brought to a defined, higher moisture content.

A plurality of spacers 3 are introduced into the module housing 2, the spacers having a plate-shaped design and extending parallel to each other. As is apparent from the enlarged illustration according to FIG. 2, the plate-shaped spacers 3 protrude into every other pleat of the membrane 7. Every spacer 3 is held on a base plate 4, which is part of the module housing 2. The spacers 3 are located in those pleats through which the moist gas flow 5 flows, which is the exhaust gas flow of the fuel cell. Since the exhaust gas flow 5 has a lower pressure than the fresh air flow 6, it suffices if the pleats of the membrane 7 are supported on the side having the lower pressure. On the fresh air side, which has a higher pressure, in contrast no support of the pleats of the membrane 7 is required.

So as to stabilize the membrane, a respective support grid made of plastic or metal can be disposed on one side, or optionally on both membrane sides, the support grid extending at least substantially across the entire surface of the membrane and, similarly to the membrane, having a pleated design.

Flow openings 8 and 9 are introduced into the base plate 4 of the housing 2, which extend across the width of the base plate 4 and via which the exhaust gas flow 5 enters or exits. The flow openings 8, 9 extend across all spacers 3. In this way, the exhaust gas flow 5 reaches the region of the pleats of the membrane 7 into which the spacers 3 protrude.

As is apparent from FIG. 2, the spacers 3 in each case comprise a plate-shaped base carrier 10 and transverse sections 11 extending transversely to the plane of the base carrier 10 on both sides. The transverse sections 11 held on the base carrier 10 form a meander structure, so that a meander-shaped flow channel is formed on each of the two lateral surfaces of the base carrier 10 through which the exhaust gas flow 5 is conducted (FIG. 4). The meander-shaped structure on the lateral surfaces of the base carrier 10 lengthens the flow path of the exhaust gas flow between inlet and outlet, and thus the moisture exchange rate.

As is furthermore apparent from FIG. 2, the transverse sections 11 on the base carrier 10 of the spacer 3 have a decreasing width in the direction of the pleat base, which complements the tapering pleat width. The transverse sections 11 extend on both sides of the base carrier 10. The free end faces of the transverse sections 11 hold the membrane side 7 seated thereon at a distance, or give the membrane 7 the pleated form.

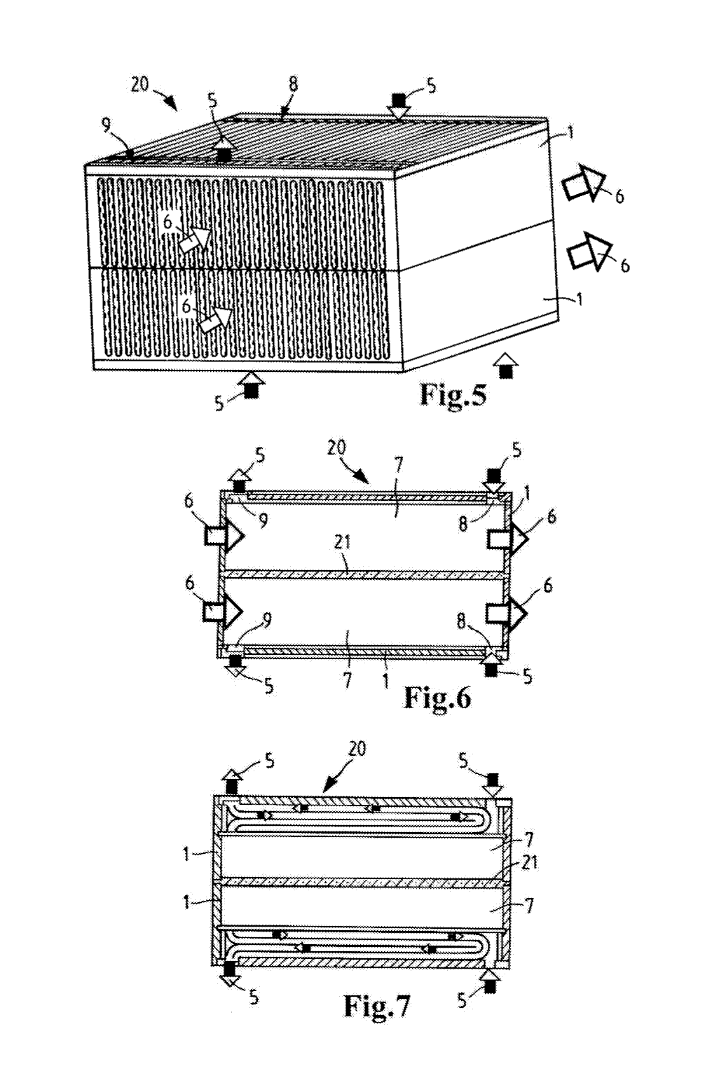

FIGS. 5 to 7 show a humidifier 20, which is composed of two separately implemented humidification modules 1 stacked on top of each other, wherein each humidification module 1 is designed in the manner described in FIGS. 1 to 4 and comprises a respective pleated membrane. The two humidification modules 1 can optionally be connected by way of connecting elements and are placed against each other in a mirror-inverted manner, so that the bottom of the upper humidification module coincides with the cover of the lower humidification module. The module housings are placed on top of each other in such a way that a shared, smooth lateral wall is formed. The bottom of the upper humidification module and the cover of the lower humidification module are removed, so that a shared flow chamber is formed between the upper and the lower membranes.

As is apparent from FIG. 5 in conjunction with the sectional views according to FIGS. 6 and 7, the supply of moist exhaust gas flow 5 via a respective flow opening 8 and the discharge via a respective flow opening 9 take place separately for the two humidification modules. The incident flow for the humidification module 1 located at the top occurs from above via the flow opening 8, and after having passed through the humidification module 1, the gas flow can exit the module again via the flow opening 9. The incident flow and discharge of the exhaust gas flow 5 takes place in corresponding fashion for the humidification module 1 located at the bottom via lower flow openings 8, 9 located in the bottom.

In contrast, the incident flow and discharge of the second gas flow 6—the fresh air flow—takes place in each case via a shared lateral surface of the two humidification modules 1. This allows the gas flow 6 to be introduced into the humidifier 20 via a shared supply connector, for example, and to be discharged from the humidifier 20 via a shared discharge connector.

A separating element 21 made of nonwoven fabric is located inside the humidifier 20 and divides the shared flow chamber in the humidifier 20 into which the gas flow 6 is introduced into a lower and an upper region, which are associated with the lower and the upper humidification module 1. In this way, the introduced gas flow 6 is separated into two partial flows, which has the advantage that each partial flow 6 in the humidification modules 1 has a longer residence time directly on each membrane 7 inside the humidification modules. This improves the exchange of moisture between the gas flows 5 and 6.

What is claimed is:

1. A humidifier, such as for a fuel cell, comprising:
at least two membranes that are permeable to water, along which a gas flow having a higher moisture content and a gas flow having a lower moisture content are conducted in each case on opposing sides of each membrane;
wherein the membranes have pleats;
wherein the membranes and are arranged on top of each other in the humidifier.

2. The humidifier according to claim 1, further comprising
a separating element separating the higher moisture gas flow and the lower moister gas flow, the separating element disposed between the two of the at least two membranes.

3. The humidifier according to claim 2, wherein
the separating element is implemented as a nonwoven fabric.

4. The humidifier according to claim 1, wherein
each membrane of the at least two membranes is disposed in a separate humidification module and the humidification modules are stackable.

5. The humidifier according to claim 4, wherein
the humidification modules are stacked in a mirror-symmetrical manner.

6. The humidifier according to claim 2, wherein
each humidification module comprises
at least one module housing having sides and having no bottom plate or cover plate, and
wherein the module housings having the missing bottom plate or cover plate have sides are arranged directly on top of each other.

7. The humidifier according to claim 1, further comprising
spacers inserted into the membrane pleats of the membrane.

8. The humidifier according to claim 7, wherein
the spacers are designed as a rectangular insertion part, which is held on a base plate.

9. The humidifier according to claim 7, wherein the spacers comprise
a base carrier;
laterally protruding transverse sections disposed on the base carrier;
wherein a membrane of the at least two membranes is supported on the laterally protruding transverse sections.

10. The humidifier according to claim 9, wherein
the transverse sections form a meander-shaped flow channel along the base carrier.

11. The humidifier according to claim 1, further comprising
a support grid seated against at least one side of the at least two membranes, the support grid extending at least approximately across an entire surface of the membrane.

12. A fuel cell comprising a humidifier according to claim 1.
